(19) United States
(12) Patent Application Publication
(10) Pub. No.: US 2019/0089860 A1
(43) Pub. Date: Mar. 21, 2019

(54) IMAGE PROCESSING DEVICE, IMAGE PROCESSING METHOD, AND NON-TRANSITORY STORAGE MEDIUM

(71) Applicants: KABUSHIKI KAISHA TOSHIBA, Tokyo (JP); TOSHIBA TEC KABUSHIKI KAISHA, Tokyo (JP)

(72) Inventor: Takahiro Fuchigami, Yokosuka Kanagawa (JP)

(21) Appl. No.: 15/709,792

(22) Filed: Sep. 20, 2017

(51) Int. Cl. H04N 1/195; H04N 1/00; H04N 1/10

(52) U.S. Cl. CPC H04N 1/19594; H04N 1/00559; H04N 1/00541; H04N 2201/0094; H04N 2201/0081; H04N 2201/0084; H04N 1/1061

(57) ABSTRACT

According to one embodiment, an image processing device includes a document table, a scanner, a document table cover, a holder, a communication interface, and a processor. The holder is provided in the side end portion of the document table cover, and holds a mobile terminal provided with a camera in the upper part of the document table, in a state in which the document table cover is stopped in the open state. The processor obtains image data in which the document table is captured from the upper part using the camera of the mobile terminal, and generates image data on both faces of the original document in which image data obtained from the mobile terminal, and image data read by the scanner are combined.

### FIELD

Embodiments described herein relate generally to an image processing device, an image processing method, and a non-transitory storage medium.

### BACKGROUND

In the related art, a large-scaled mechanism such as a document feeder (DF) is necessary for a scanner when automatically scanning both faces of the original document. Meanwhile, high performance of a mobile terminal such as a smart phone is progressing. For example, in a mobile terminal on which a camera is mounted, there is a mobile terminal which has a function of outputting image data captured by a camera to an image processing device such as a digital multi-functional peripheral or a printer. However, in the related art, it is not easy to simply obtain image data on both faces of the original document by causing a scanner and a mobile terminal to cooperate in a simple configuration.

### DESCRIPTION OF THE DRAWINGS

FIG. 1 is a diagram which schematically illustrates a configuration example of a digital multi-functional peripheral as an image processing device, and a mobile terminal.

FIG. 2 is a block diagram which illustrates a configuration example of a control system in the digital multi-functional peripheral as the image processing device.

FIG. 3 is a block diagram which illustrates a configuration example of a mobile terminal.

FIG. 4 is a diagram which illustrates an example of a captured image which is captured by a camera of the mobile terminal.

FIG. 5 is a diagram which illustrates an example of a captured image which is captured by the camera of the mobile terminal.

FIG. 6 is a diagram which illustrates an example of a captured image which is captured by the camera of the mobile terminal.

FIG. 7 is a diagram which illustrates an example of a captured image which is captured by the camera of the mobile terminal.

FIG. 8 is a flowchart which describes an operation example of double-sided processing of the original document which is performed in cooperation with the mobile terminal using the digital multi-functional peripheral.

FIG. 9 is a flowchart which describes an operation example of adjusting processing of an effective capturing range using the digital multi-functional peripheral.

FIG. 10 is a flowchart which describes an operation example of a mobile terminal in the adjusting processing of the effective capturing range using the mobile terminal.

FIG. 11 is a flowchart which describes an operation example of double-sided reading processing using the digital multi-functional peripheral.

FIG. 12 is a flowchart which describes an operation example of double-sided reading processing using the mobile terminal.

FIG. 13 is a diagram which illustrates an example of a captured image in which a scanner of a digital multi-functional peripheral according to a modification example is captured from the upper part of the document table.

FIG. 14 is a diagram which illustrates an example of a captured image which is captured by a camera of a mobile terminal according to the modification example.

FIG. 15 is a diagram which illustrates an example of a difference image between the captured image illustrated in FIG. 14 and the captured image (reference image) illustrated in FIG. 13.

FIG. 16 is a flowchart which describes an operation example of setting processing of a reference image using the digital multi-functional peripheral according to the modification example.

FIG. 17 is a flowchart which describes an operation example of setting processing of the reference image using the mobile terminal according to the modification example.

FIG. 18 is a flowchart which describes an operation example of double-sided reading processing using the digital multi-functional peripheral according to the modification example.

FIG. 19 is a flowchart which describes an operation example of double-sided reading processing using the mobile terminal according to the modification example.

### DETAILED DESCRIPTION

An object of an exemplary embodiment is to provide an image processing device, an image processing method, and a non-transitory storage medium in which it is possible to simply obtain desired image data by causing a scanner and a mobile terminal to cooperate in a simple configuration.

According to an embodiment, an image processing device includes a document table, a scanner, a document table cover, a holder, a communication interface, and a processor. The document table has the original document reading region on which the original document is placed. The scanner reads an image of the original document in the original document reading region from under the document table. The document table cover includes a mechanism which is openable and closeable, covers the original document reading region in a closed state, and a side end portion thereof stops above the original document reading region in an open state. The holder is provided in the side end portion of the document table cover, and holds a mobile terminal provided with a camera in the upper part of the document table, in a state in which the document table cover is stopped in the open state. The communication interface communicates with the mobile terminal which is held by the holder. The processor obtains image data in which the document table is captured from the upper part, using the camera of the mobile terminal, and generates image data on both faces of the original document in which image data obtained from the mobile terminal, and image data read by the scanner are combined.

Hereinafter, an embodiment will be described using drawings.

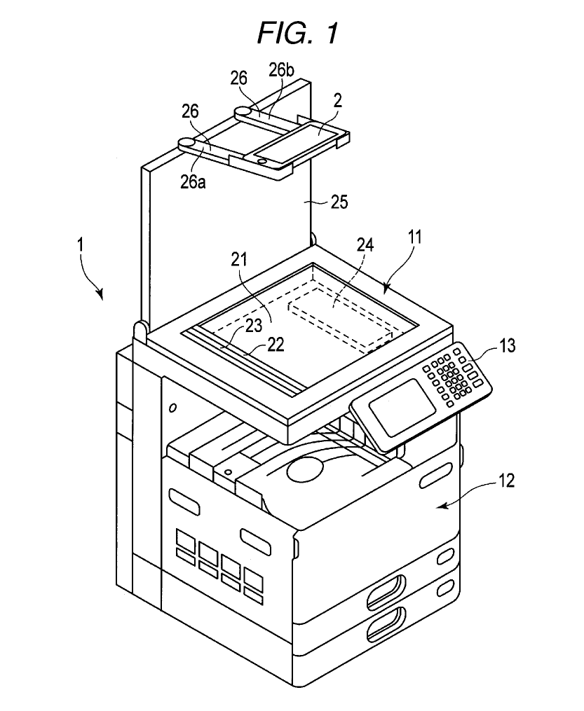

FIG. 1 is a diagram which schematically illustrates a configuration example of an image reading system according to the embodiment.

The image reading system illustrated in FIG. 1 is a system which includes a digital multi-functional peripheral 1 including an image reading apparatus, and a mobile terminal 2. The digital multi-functional peripheral (MFP) 1 is an image processing device which includes a scanner 11 as an image reading apparatus. The MFP 1 includes a printer 12 as an image forming apparatus, an operation panel 13, and the like. The mobile terminal 2 is a mobile electronic apparatus which has a function of communicating with a camera and an MFP. The mobile terminal 2 is a smart phone, a mobile phone, a tablet PC, or a digital camera with a communication function, which is possessed by a user, for example.

First, a configuration of the digital multi-functional peripheral (MFP) 1 will be described.

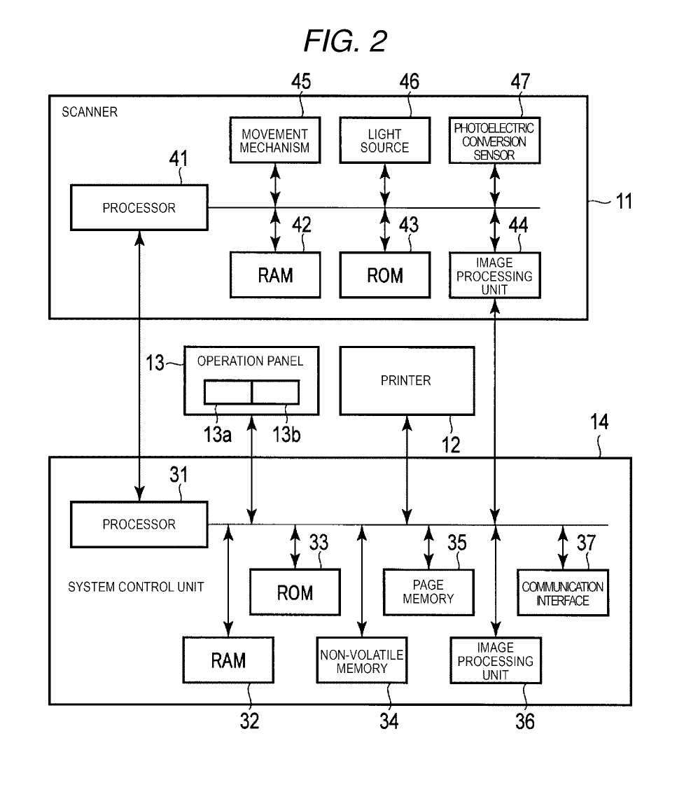

As illustrated in FIG. 1, the digital multi-functional peripheral 1 includes the scanner 11, the printer 12, and the operation panel 13. The digital multi-functional peripheral 1 further includes a system control unit 14 (refer to FIG. 2) not illustrated in FIG. 1 in a main body. The system control unit 14 is connected to the scanner 11, the printer 12, and the operation panel 13, and performs a control of each unit, data processing, and the like.

The scanner 11 is provided at the upper part of the main body of the digital multi-functional peripheral 1. The scanner 11 is an image reading apparatus which optically reads an image of the original document, and converts the image into image data. A configuration example of the scanner 11 will be described later.

The printer 12 prints an image on a sheet as a medium for image forming. For example, the printer 12 prints an image of the original document which is read by the scanner 11 on a sheet. In addition, the printer 12 may print an image on a sheet based on image data which is received through a network, or the like. An image forming method of the printer 12 is not limited to a specific method, and the printer may be an electro-photographic printer, an ink jet printer, and a thermal transfer printer.

The operation panel 13 is a user interface. The operation panel 13 includes a display unit 13a which displays a guide, or the like, and an operation unit 13b such as an operation button, or a touch panel which receives an input of an icon. A user instructs a start of scanning, or copying, in the operation panel 13. In addition, in double-sided processing of the original document in which the MFP 1, which will be described later, and the mobile terminal 2 are caused to cooperate, an operation instruction is input, in the operation panel 13.

Subsequently, a configuration of the scanner 11 will be described.

In the configuration example illustrated in FIG. 1, the scanner 11 is installed at the upper part of the main body of the digital multi-functional peripheral. The scanner 11 includes a document table 21, carriage 22, a lighting unit 23, a photoelectric conversion unit 24, a document table cover 25, a holding stay 26, and the like.

The document table 21 is a table on which the original document is placed. The document table 21 is configured of a transparent member such as glass.

The lighting unit 23, and an optical system such as a mirror are mounted on a carriage 22. The lighting unit 23 is configured of a light source 46 (refer to FIG. 2) which emits light. The lighting unit 23 is configured so as to radiate light emitted from the light source 46 to the document table 21. In the configuration illustrated in FIG. 1, the lighting unit 23 radiates light to a reading position in the document table 21. The reading position on the document table 21 to which the lighting unit 23 radiates light includes an image region of one line (or, of plurality of lines) in the main scanning direction. The optical system such as the mirror mounted on the carriage 22 guides light (reflected light) from the reading position to which the lighting unit 23 radiates light to the photoelectric conversion unit 24.

The carriage 22 moves the lower part of the document table 21 using a movement mechanism 45 (refer to FIG. 2) including a stepping motor, or the like, in the sub-scanning direction. A position of the carriage 22 is decided in an initial operation, and a movement in the sub-scanning direction is controlled based on the decided position. For example, the carriage 22 continuously guides an image in each line in the main scanning direction to the photoelectric conversion unit 24 in a region in which the original document on the document table 21 is mounted (original document reading region), by moving in the sub-scanning direction. That is, the entire original document reading region on the document table 21 is illuminated when the carriage 22 moved in the sub-scanning direction.

The photoelectric conversion unit 24 includes a lens, a photoelectric conversion sensor 47 (refer to FIG. 2), a cover, and the like. The lens condenses light which is guided by the optical system of the carriage 22, and guides the light to the photoelectric conversion sensor 47. The photoelectric conversion sensor 47 is configured of a photoelectric conversion element. The photoelectric conversion sensor 47 is a line sensor in which CCDs or CISs as the photoelectric conversion element are aligned in a line shape, for example. The line sensor as the photoelectric conversion sensor 47 converts an image of one line (reflected light on original document face) in the main scanning direction to pixel data of one line. In addition, the cover is configured so as to cover the photoelectric conversion sensor 47.

The document table cover 25 is installed so as to be openable or closeable. The document table cover 25 covers the original document reading region in the document table 21 in a closed state. The document table cover 25 has a function of being stopped in an open state. In the document table cover 25, a side end portion on the near side stops at a position which is the upper part of the original document reading region in the document table 21, in the open state.

The holding stay 26 is provided at the side end portion on the near side in the document table cover 25. The holding stay 26 holds the mobile terminal 2. The holding stay 26 includes a first stay 26a and a second stay 26b. The first stay 26a and the second stay 26b interpose the mobile terminal 2 therebetween, for example. The first stay 26a and the second stay 26b hold the mobile terminal 2 so that a camera 2a faces the document table 21, at the side end portion of the document table cover 25 in an open state.

For example, the first stay 26a and the second stay 26b are installed so as to be rotatable, respectively, by setting an installation portion to a rotation center, at the side end portion of the document table cover 25. When the mobile terminal 2 is held, the first stay 26a and the second stay 26b are moved to a position at which the mobile terminal 2 is interposed. The first stay 26a and the second stay 26b are configured so as to be stored along the side end portion of the document table cover 25, in a state in which the document table cover 25 is closed. In this manner, the holding stay 26 can be stored by being folded so as not to be obstructive when opening or closing the document table cover 25, when the mobile terminal 2 is not used.

The first stay 26a and the second stay 26b are moved to a position of interposing the mobile terminal 2 therebetween, in a state in which the document table cover 25 is opened. As illustrated in FIG. 1, the first stay 26a and the second stay 26b hold the mobile terminal 2 in a state in which the camera 2a faces the document table 21, in a state in which the document table cover 25 is opened. For example, it is set so that the first stay 26a and the second stay 26b can be opened in a state in which the document table cover 25 is fully opened. In this manner, it is possible to set a camera 55 to be approximately parallel to a face of the document table 21 on which the original document is placed, when the mobile terminal 2 is mounted so that the camera 55 faces downward, by opening the holding stay 26.

Subsequently, a configuration of a control system of the digital multi-functional peripheral 1 will be described.

FIG. 2 is a block diagram which describes a configuration example of the control system in the digital multi-functional peripheral 1.

The digital multi-functional peripheral 1 includes a system control unit 14 which controls the entire apparatus. The system control unit 14 is connected to the scanner 11, the printer 12, and the operation panel 13 through a system bus, or the like.

In the configuration example illustrated in FIG. 2, the system control unit 14 includes a processor 31, a RAM 32, a ROM 33, a non-volatile memory 34, a page memory 35, an image processing unit 36, and a communication interface 37.

The processor 31 controls the entire digital multi-functional peripheral. The processor 31 includes an operating circuit which executes various processing, by executing a program. The processor 31 is a CPU, for example. The processor 31 is connected to each unit in the apparatus through the system bus. The processor 31 inputs information denoting a detection signal, an operation state, and the like, of various sensors which are installed in each unit in the apparatus.

The processor 31 can be connected not only to each unit in the system control unit 14 but also to the scanner 11, the printer 12, the operation panel 13, and the like, through the system bus. The processor 31 outputs an operation instruction to each unit, or obtains various information from each unit by performing a bidirectional communication among the scanner 11, the printer 12, and the operation panel 13.

The RAM 32 functions as a working memory, or a buffer memory. The ROM 33 is a non-rewritable and non-volatile memory which stores a program, control data, and the like. The processor 31 executes various processing by executing a program stored in the ROM 33 (or, in non-volatile memory 34) while using the RAM 32. For example, the processor 31 executes a control of communicating with the mobile terminal 2, generating processing of an image file, or the like, by executing the program.

The non-volatile memory 34 is a rewritable non-volatile memory. The non-volatile memory 34 stores a control program executed by the processor 31, and control data. In addition, the non-volatile memory 34 stores set information, processing conditions, or the like.

The page memory 35 is a memory for developing image data as a processing target. For example, the page memory 35 stores image data which is read by the scanner 11 or image data which is captured by the mobile terminal 2.

The image processing unit 36 has an input image processing function in which input image data is processed, and an output image processing function in which image data to be output is processed. For example, the image processing unit 36 performs a resolution conversion, adjusting of brightness, adjusting of contrast, adjusting of chroma, adjusting of sharpness, or the like, with respect to image data as the input image processing function. The image processing unit 36 has a processing function of converting into image data for printing, as the output image processing function. The image processing unit 36 may have a compression processing function in which image data is compressed, and an extension processing function in which compressed image data is extended.

The communication interface 37 is an interface for communicating with the mobile terminal 2. For example, the communication interface 37 communicates with the mobile terminal 2 using wireless communication. The communication interface 37 may be an interface which communicates with the mobile terminal 2 using short-distance wireless communication. In addition, the communication interface 37 may have a function as an interface for communicating with an external device such as a server through a network.

In the configuration example illustrated in FIG. 2, the scanner 11 includes a processor 41, a RAM 42, a ROM 43, an image processing unit 44, a movement mechanism 45, a light source 46, and a line sensor 47 as a configuration of a control system.

The processor 41 controls the scanner 11. The processor 41 includes an operating circuit which executes processing by executing a program. The processor 41 is a CPU, for example. The processor 41 is connected to each unit in the scanner 11 through a system bus. In addition, the processor 41 is also connected to the system bus in the system control unit 14. The processor 41 controls an operation of the scanner 11 according to an operation instruction from the processor 31 of the system control unit 14. In addition, the processor 41 outputs an output signal of each sensor in the scanner 11 to the system control unit 14.

The RAM 42 functions as a working memory or a buffer memory. The ROM 43 is a non-volatile memory which stores a program, control data, and the like. In addition, as the ROM 43, a rewritable non-volatile memory which stores a program, control data, information to be set, processing conditions, and the like, may be included. The processor 41 executes various processing by executing a program which is stored in the ROM 43 while using the RAM 42.

The image processing unit 44 has a function of processing image data (output signal of line sensor 47) which is scanned. For example, the image processing unit 44 executes shading correction processing, grayscale conversion processing, correction processing between lines, and the like, with respect to image data which is read by the scanner 11.

The movement mechanism 45 is a mechanism which moves the carriage 22. The movement mechanism 45 includes a stepping motor as a driving source, and moves the carriage 22 by driving the stepping motor. The movement mechanism 45 moves the carriage 22 according to an operation instruction from the processor 31 of the system control unit 14 or the processor 41. For example, the processor 41 moves the carriage 22 from a reading start position in the sub-scanning direction (FWD direction) when the original document on the document table 21 is scanned. In addition, the processor 41 moves the entire original document reading region of the carriage 22 when the entire original document reading region is also illuminated.

The light source 46 configures the lighting unit 23. The light source 46 emits light which radiates the original document reading region of the document table 21. The light source 46 emits light according to a lighting instruction from the processor 41. The light source 46 is not limited to a specific configuration. The light source 46 may be a light source in which radiated light is input to the photoelectric conversion sensor 47 as reflected light from the original document which is mounted on the original document reading region in the document table 21.

The photoelectric conversion sensor 47 is configured of a photoelectric conversion element which converts input light into an electric signal. According to the embodiment, the photoelectric conversion sensor 47 is set to a line sensor which generates pixel data of lines which are read in the main scanning direction. Light guided by an optical system which is mounted on the carriage 22 is input to the photoelectric conversion sensor 47 through a lens. The carriage 22 guides light of lines which are read in the main scanning direction in the original document reading region of the document table 21 to the photoelectric conversion unit 24. The photoelectric conversion unit 24 condenses light from the carriage 22 using the lens, and inputs the light to the photoelectric conversion sensor 47. The photoelectric conversion sensor 47 successively outputs pixel data of lines which are read in the main scanning direction on the original document face, according to a movement of the carriage 22 in the sub-scanning direction. In this manner, the photoelectric conversion sensor 47 outputs pixel data of the entire original document face.

The system control unit 14 may be set so as to function as a control unit of the scanner 11, and configure an image reading apparatus (image processing device) using the scanner 11 and the system control unit 14. It may be a configuration in which the scanner 11 is realized as the image reading apparatus, when the processor 41 has the same function as that of the processor 31 of the system control unit 14 which will be described later. In descriptions below, it is set so that the processor 31 of the system control unit 14 mainly executes various processing functions. However, these processing functions may be executed by the processor 41 of the scanner 11.

Subsequently, a configuration of the mobile terminal 2 will be described later.

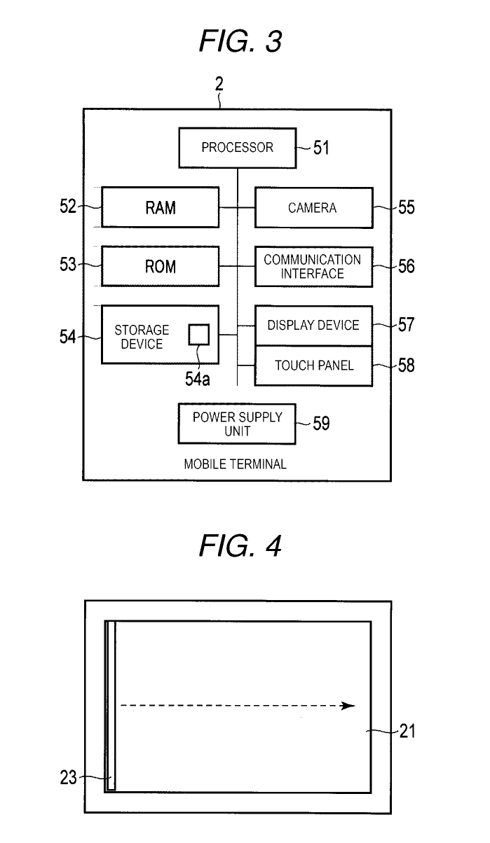

FIG. 3 is a block diagram which illustrates a configuration example of the mobile terminal 2.

As illustrated in FIG. 3, the mobile terminal 2 includes a processor 51, a RAM 52, a ROM 53, a storage device 54, the camera 55, a communication interface 56, a display device 57, a touch panel 58, a power supply unit 59, and the like. The processor 51 is connected to the RAM 52, the ROM 53, the storage device 54, the camera 55, the communication interface 56, the display device 57, the touch panel 58, and the power supply unit 59. In addition, the power supply unit 59 includes a battery which supplies power to each unit, and is electrically connected so that power from the battery can be supplied to each unit.

The processor 51, the RAM 52, and the ROM 53 configure a control unit which controls the mobile terminal 2. The processor 51 executes various processing functions by executing a program. The processor 51 is a CPU, for example. The processor 51 is connected to each unit in the mobile terminal 2 through a bus. The processor 51 executes various processing by executing a program which is stored in the ROM 53 or the storage device 54. For example, the processor 51 executes a basic operation control of the mobile terminal 2 by executing a program of an operating system (OS). The processor 51 executes various processing by executing an application program (application) which is designed according to processing contents.

The RAM 52 and the ROM 53 configure a system memory for causing the processor 51 to be operated. The RAM 52 is a volatile memory. The RAM 52 is used as a work area in which data temporarily used is stored. The ROM 53 is a non-volatile memory. The ROM 53 stores various programs such as an OS program which is executed by the processor 51, or an application.

The storage device 54 is a rewritable non-volatile memory. The storage device 54 is configured of, for example, an HDD, an SSD, an EEPROM (registered trademark), or the like. In addition, the storage device 54 stores various applications, control data, user data, and the like. The storage device 54 includes a storage region 54a as a storage medium in which an application is stored. For example, the storage region 54a stores an application for communicating with the MFP 1, an application which extracts an original document image from an image captured by the camera 55, and the like. In addition, the storage region 54a may store an application in which image data on both faces of the original document are set to a file from an image read by the scanner 11 and an image read by the camera 55.

The camera 55 captures an image. The camera 55 captures an image in a region including the original document reading region on the document table 21 in a state of being set in the holding stay 26 of the MFP 1. The camera 55 may be a general camera mounted on a smart phone, a mobile phone, a tablet PC, or the like, which is used as the mobile terminal 2. In addition, the mobile terminal 2 may be a terminal which is provided with a light which illuminates a region captured by the camera 55.

The communication interface 56 is an interface for communicating with the MFP 1. According to the embodiment, the communication interface 56 is set to an interface for communicating with the MFP 1 using short-distance wireless communication. As the short-distance wireless communication using the communication interface 56, communication using non-contact communication such as NFC may be included. In addition, the communication interface 56 may be an interface for communicating with the MFP 1 through a wireless LAN, or the like, and may be an interface for performing communication in a wired manner.

In the display device 57, display contents, or the like, is controlled by the processor 51. The touch panel 58 is an input device for inputting an operation instruction by a user. As the input device, a button such as a ten key, a keyboard, or the like, may be provided, in addition to the touch panel. The touch panel 58 supplies an operation instruction which is input by a user to the processor 51. For example, the display device 57 and the touch panel 58 are integrally configured as a display device with a touch panel.

Subsequently, a processing example in which image data in an original document region is obtained from a captured image captured by the camera 55 of the mobile terminal 2 will be described.

FIG. 4 is a diagram which illustrates an example of a captured image which is captured by the camera 55 of the mobile terminal 2 which is set in the holding stay 26.

The mobile terminal 2 is set in the holding stay 26 by causing the camera 55 to face the document table 21, in a state in which the document table cover 25 is open. The camera 55 of the mobile terminal 2 which is set in the holding stay 26 in this state captures an image in a capturing range including the original document reading region of the document table 21. In this case, as illustrated in FIG. 4, the image which is captured by the camera 55 becomes an image which includes an image of the original document reading region of the document table 21, and images at the periphery of the original document reading region.

In the embodiment, the mobile terminal 2 which is set in the holding stay 26 adjusts (sets) the original document reading region in an image captured by the camera 55 as an effective capturing range in advance. The mobile terminal 2 extracts image data of the original document from an image captured by the camera 55 based on the adjusted effective capturing range. The process of adjusting the effective capturing range (adjusting processing of effective capturing range) is described as processing performed by the mobile terminal 2; however, the MFP 1 may perform the processing.

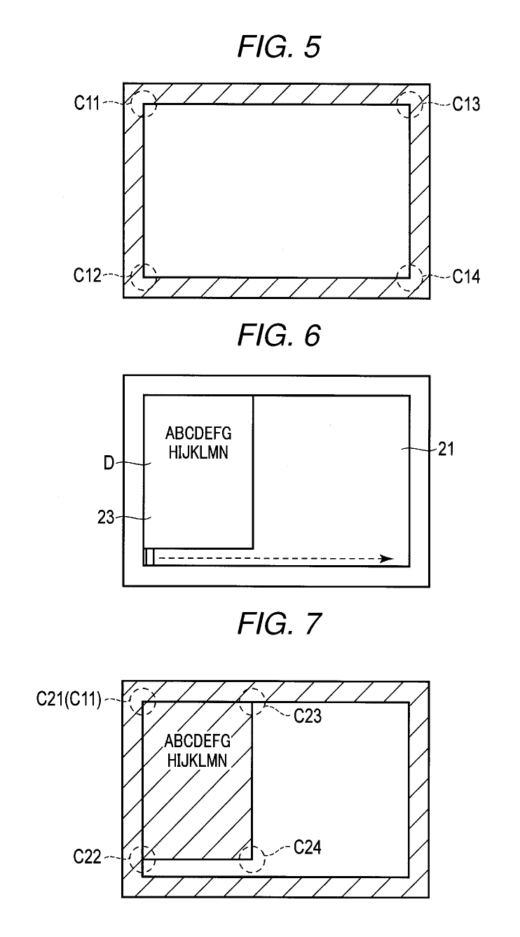

FIG. 5 is a diagram which illustrates an example of an image captured by the camera 55 of the mobile terminal 2 in a state in which the entire original document reading region is illuminated with light.

The camera 55 captures halation image in an overexposure state, when a light which the camera 55 faces is turned on. When the carriage 22 is moved in the sub-scanning direction in a state in which the lighting unit 23 is turned on, the camera 55 captures the original document reading region as a halation image region, when there is no original document on the document table 21.

For example, the mobile terminal 2 captures an image by setting the camera 55 to a long-time exposure mode, while the carriage 22 in which the lighting unit 23 is turned on is moving in the original document reading region. Then, as illustrated in FIG. 5, the camera 55 captures an image in which the original document reading region becomes a halation image (white image). The mobile terminal 2 can detect an effective capturing range corresponding to the original document reading region by detecting four corners c11, c12, c13, and c14 which form a rectangular region of a white image, in the captured image illustrated in FIG. 5. On the premise that a position of the mobile terminal 2 is not changed, it is possible to specify the original document reading region in the captured image illustrated in FIG. 4, by setting a region of the white image in the captured image illustrated in FIG. 5 to an effective capturing range.

It is also possible to specify distortion, or the like, which is caused by an inclination of the mobile terminal 2, or the like, based on a shape of a region of the white image in the captured image illustrated in FIG. 5. When distortion of the captured image is specified, it is also possible to perform an image correction such as a rotation using affine transformation, or the like, when cutting out an image in the original document reading region from a captured image according to the distortion. In addition, marks, or the like, which denotes four end points of the original document reading region may be provided on the document table 21. In this case, it is also possible to detect the original document reading region by detecting four marks from the captured image.

Subsequently, an example of detecting processing in which an original document region is detected will be described.

FIG. 6 is a diagram which illustrates an example of an image captured by the camera 55 in a state in which the original document D is mounted on the document table 21. FIG. 7 is a diagram which illustrates an example of an image captured by the camera 55 in a state in which the entire original document reading region is illuminated with light, while mounting the original document on the document table 21.

The captured image illustrated in FIG. 6 includes an original document image in which the original document D mounted on an effective capturing range (original document reading region of document table 21) is captured from the upper part. The mobile terminal 2 detects the original document region from the effective capturing range in the captured image illustrated in FIG. 6, and extracts image data of the original document region.

When the carriage 22 is moved in the sub-scanning direction by turning on the lighting unit 23 while placing the original document D on the document table 21, the camera 55 captures the image illustrated in FIG. 7. The mobile terminal 2 captures an image by setting the camera 55 to a long-time exposure mode, while the carriage 22 in which the lighting unit 23 is turned on is moving in the original document reading region. The original document on the document table 21 shuts off light from the lighting unit 23. For this reason, the captured image illustrated in FIG. 7 becomes an image in which a certain portion (original document region) of the original document on the document table 21 is dark due to light from under the document table 21.

The captured image illustrated in FIG. 7 is an image in which a portion with no original document becomes a halation image. When the original document is rectangular, the mobile terminal 2 can detect an original document region by detecting four corners c21, c22, c23, and c24 which form a rectangular region of a dark image in the captured image illustrated in FIG. 7. For example, the corners in the original document region can be detected based on end points in a boundary between a white image and a dark image, and end points in the effective capturing range. For example, in the captured image illustrated in FIG. 7, the corner c21 in the upper left portion is not easy to be detected as an end portion of the dark image; however, it can be detected as the endpoint c11 in the effective capturing range. The mobile terminal 2 can extract image data in the original document region from the captured image illustrated in FIG. 6 based on an image region of the original document which is detected in the captured image in FIG. 7.

Subsequently, double-sided processing of the original document using cooperation between the MFP 1 in the embodiment and the mobile terminal 2 will be described.

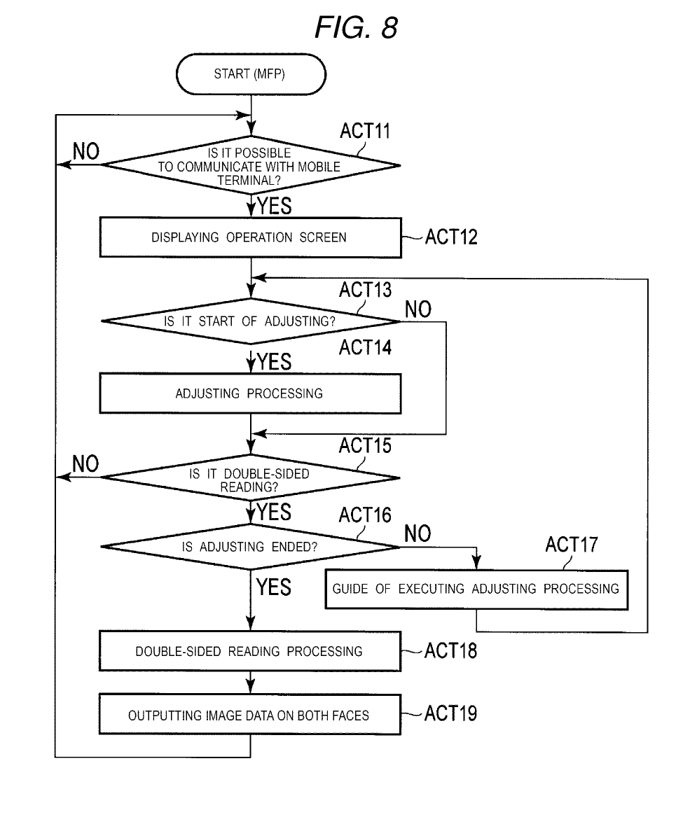

FIG. 8 is a flowchart which describes an operation example when executing reading processing of both faces of the original document (double-sided processing of original document) by cooperation between the MFP 1 and the mobile terminal 2.

First, a user starts up an application for causing the MFP to cooperate, in the mobile terminal 2. When the application for causing the MFP to cooperate is started up, the user sets the mobile terminal 2 in the holding stay 26 in a state in which the document table cover 25 is opened. The processor 51 of the mobile terminal 2 sends a connection request to the MFP 1 through the communication interface 56, by executing an application.

The system control unit 14 of the MFP 1 receives the connection request from the mobile terminal 2 using the communication interface 37. The processor 31 of the system control unit 14 performs a communication connection to the mobile terminal 2 according to the connection request from the mobile terminal 2 (Yes in ACT 11). When the communication connection with the mobile terminal 2 is established, the processor 31 displays an operation screen for a cooperation operation with the mobile terminal 2 on the operation panel 13, as an operation mode in which an operation cooperated with the mobile terminal 2 is possible (ACT 12). For example, the operation panel 13 displays the operation screen for the cooperation operation including a button for instructing a start of adjusting processing of the effective capturing range which can be selected in a touch panel 13b on a display unit 13a.

When the start of adjusting processing of the effective capturing range is instructed (Yes in ACT 13), the processor 31 executes the adjusting processing of the effective capturing range (ACT 14). The adjusting processing of the effective capturing range is processing for setting the original document reading region in an image captured by the camera 55 of the mobile terminal 2 to the effective capturing range. The adjusting processing of the effective capturing range will be described in detail later.

In addition, the processor 31 receives processing for reading both faces of the original document on the document table 21 (hereinafter, referred to as double-sided reading processing) using the camera 55 of the mobile terminal 2 (ACT 15). When the double-sided reading processing is instructed in the operation panel 13 (Yes in ACT 15), the processor 31 checks whether or not the adjusting processing of the effective capturing range is completed (ACT 16).

When the adjusting processing of the effective capturing range is not completed (No in ACT 16), the processor 51 displays a guide which promotes executing of the adjusting processing of the effective capturing range (ACT 17), and returns to ACT 13. When double-sided reading presupposes a completion of the adjusting processing of the effective capturing range, the processor 31 may set the instruction of the double-sided reading processing to be ineffective until the adjusting processing of the effective capturing range is completed.

When the adjusting processing of the effective capturing range is completed (Yes in ACT 16), the processor 51 executes the double-sided reading processing which is cooperated with the mobile terminal 2 (ACT 18). Here, the double-sided reading processing is processing in which an image on a first face (front face) of the original document which is read by the scanner 11, and an image on a second face (rear face) of the original document which is captured by the camera 55 of the mobile terminal 2 are obtained. In the double-sided reading processing, it assumes that image data (image file) on both faces of the original document including image data on the first face of the original document, and image data on the second face of the original document are generated. The double-sided reading processing cooperated with the mobile terminal 2 will be described in detail later.

When the image data on both faces of the original document are generated in the double-sided reading processing cooperated with the mobile terminal 2, the processor 31 outputs the image data on both faces of the original document (ACT 19). For example, when copying the both faces of the original document, the processor 31 generates images for printing on the first face (front face) and the second face (rear face) of a sheet, and supplies the images to the printer 12. In this manner, the printer 12 prints the images on both faces of the original document which are obtained in the double-sided reading processing on both faces of the sheet. In addition, when the both faces of the original document are supplied to the mobile terminal 2, the processor 31 supplies the generated image data on both faces to the mobile terminal 2 through the communication interface 37.

Subsequently, the adjusting processing of the effective capturing range will be described.

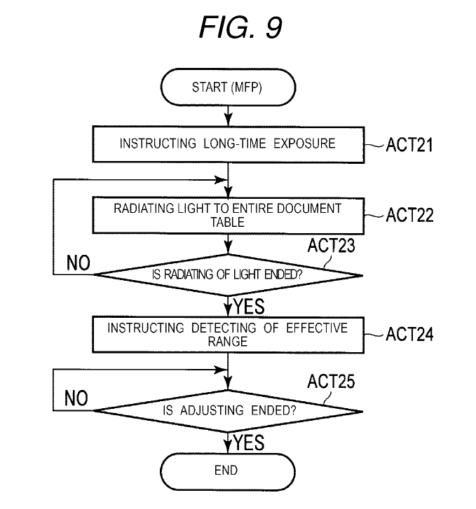

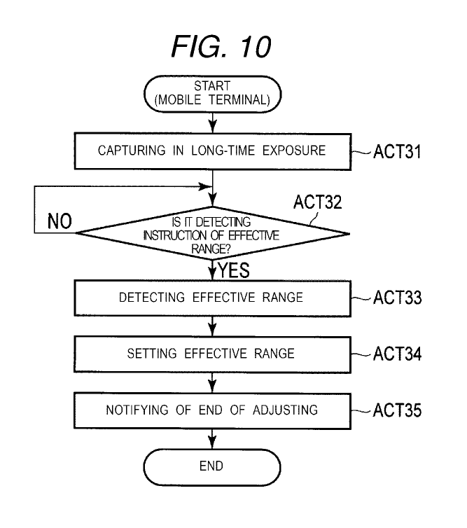

FIG. 9 is a flowchart which describes an operation example of the MFP 1 in the adjusting processing of the effective capturing range. In addition, FIG. 10 is a flowchart which describes an operation example of the mobile terminal 2 in the adjusting processing of the effective capturing range.

When the adjusting processing of the effective capturing range is instructed, as illustrated in FIG. 9, the processor 31 of the MFP 1 instructs the mobile terminal 2 to start capturing in the long-time exposure mode (ACT 21). When the start of capturing in the long-time exposure mode is instructed, the processor 31 radiates light to the entire original document reading region by moving the carriage 22, by turning on the lighting unit 23 (ACT 22).

In addition, the adjusting processing of the effective capturing range is based on the premise that the original document is not mounted on the document table 21. For this reason, the processor 31 may display a guide of not mounting the original document on the document table 21 on the operation panel 13. The processor 31 may detect that there is no original document on the document table 21 using an original document detecting sensor. In this case, when it is detected that there is the original document on the document table 21, the processor 31 may display a guide of removing the original document, or stop the processing.

When radiating of light to the entire original document reading region is completed (Yes in ACT 23), the processor 31 instructs the mobile terminal 2 to detect the effective capturing range (or, ending of capturing in long-time exposure mode) (ACT 24). After instructing the detection of the effective capturing range, the processor 31 determines that the adjusting processing of the effective capturing range is ended, based on a notification of ending of adjusting from the mobile terminal 2 (ACT 25). When it is determined that the adjusting processing of the effective capturing range is ended, the processor 31 ends the process by holding information denoting that the mobile terminal 2 ends the adjustment in the RAM 32, or the like.

Meanwhile, as illustrated in FIG. 10, the processor 51 of the mobile terminal 2 starts capturing in the long-time exposure mode using the camera 55 according to the instruction from the MFP 1 (ACT 31). The processor 51 continues capturing in the long-time exposure mode until radiating of light with respect to the entire original document reading region using the scanner 11 of the MFP 1. The processor 31 ends capturing in the long-time exposure mode using the camera 55, when receiving the instruction of detecting the effective capturing range (or, ending of capturing in long-time exposure mode) from the MFP 1 (Yes in ACT 32).

When capturing in the long-time exposure mode is ended, the processor 51 performs detecting processing of the effective capturing range based on an image captured in the long-time exposure mode using the camera 55 (ACT 33). Here, the camera 55 captures a capturing region including the entire original document reading region to which light is radiated in a state in which there is no original document on the document table 21. For this reason, as illustrated in FIG. 5, the image captured by the camera 55 is an image in which the original document reading region becomes a halation image.

As described above, the processor 51 detects the effective capturing range as the original document reading region by detecting a white image from the image captured by the camera 55. When the effective capturing range is detected, the processor 51 sets the effective capturing range by holding information denoting the effective capturing range which is detected in the memory such as the RAM 52 (ACT 34). When the effective capturing range is set, the processor 51 notifies the MFP 1 of information denoting a completion of adjusting (setting) of the effective capturing range (ACT 35), and ends the processing.

Subsequently, double-sided reading processing in which the MFP 1 and the mobile terminal 2 are cooperated will be described.

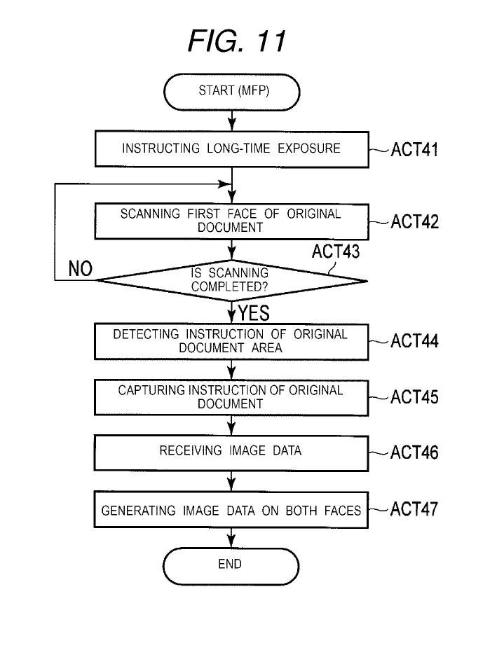

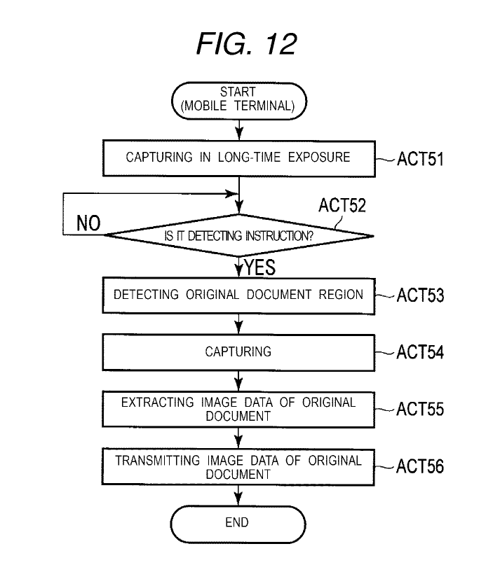

FIG. 11 is a flowchart which describes an operation example of the MFP 1 in the double-sided reading processing in which the MFP cooperated with the mobile terminal 2. In addition, FIG. 12 is a flowchart which describes an operation example of the mobile terminal 2 in the double-sided reading processing in which the mobile terminal cooperated with the MFP 1.

When the double-sided reading processing is instructed in the operation panel 13, as illustrated in FIG. 11, the processor 31 of the MFP 1 instructs the mobile terminal 2 to start capturing in the long-time exposure mode (ACT 41). After instructing the start of capturing in the long-time exposure mode to the mobile terminal 2, the processor 31 performs scanning processing in which the original document on the document table 21 is read by the scanner 11 (ACT 42). The scanner 11 optically reads an image on a lower face (first face, front face) which is placed on the document table 21. The scanner 11 supplies image data obtained by correcting an image signal taken in the photoelectric conversion sensor 47 using the image processing unit 44, or the like, to a system control unit 5 as image data on the surface of the original document. The processor 31 stores the image data on the surface of the original document supplied from the scanner 11 in the page memory 35.

In the scanning processing, the scanner 11 obtains an image signal denoting an image of the original document using the photoelectric conversion unit 24, by turning on the lighting unit 23, and moving the carriage 22. Here, in the scanning processing, the scanner 11 is set so as to radiate light to the entire original document reading region, by moving the carriage 22 in which the lighting unit 23 is turned on.

When the scanning processing is completed (Yes in ACT 43), the processor 31 instructs the mobile terminal 2 to detect an original document region (or, ending of capturing in long-time exposure mode) (ACT 44). After instructing detecting of the original document region, the processor 31 instructs the mobile terminal 2 to capture the original document (image on second face (rear face) of original document) (ACT 45). After instructing capturing of the original document, the processor 31 receives image data as an image on the second face (rear face) of the original document from the mobile terminal 2 (ACT 46).

When receiving image data from the mobile terminal 2, the processor 31 generates image data on both faces of the original document using the image data read by the scanner 11 and the image data received from the mobile terminal 2 (ACT 47). The processor 31 generates reading results on both faces of the original document in which the image data read by the scanner 11 is set to the front face of the original document, and the image data received from the mobile terminal 2 is set to the rear face of the original document. The reading results on both faces of the original document may be generated as an image file including the image data on the front face and the image data on the rear face. In addition, the processor 31 may perform processing of correcting any one, or both of image data according to characteristics of the scanner 11 and the camera 55 of the mobile terminal 2.

Meanwhile, as illustrated in FIG. 12, the processor 51 of the mobile terminal 2 starts capturing, using the camera 55 in the long-time exposure mode according to the instruction from the MFP 1 (ACT 51). The processor 51 continues capturing in the long-time exposure mode until the scanning processing using the scanner 11 of the MFP 1 is completed. The processor 51 ends capturing by using the camera 55 in the long-time exposure mode when receiving the instruction of detecting the original document region (or, ending of capturing in long-time exposure mode) from the MFP 1 (Yes in ACT 52). When ending capturing in the long-time exposure mode, the processor 51 performs detecting processing of the original document region based on the image captured by the camera 55 in the long-time exposure mode (ACT 53).

Here, the scanner 11 of the MFP 1 is set to radiate light to the entire original document reading region in the scanning processing. Accordingly, when the scanning processing by the scanner 11 ends, the image captured by the camera 55 in the long-time exposure mode becomes the image illustrated in FIG. 7. That is, in the captured image illustrated in FIG. 7, an image other than the original document region becomes a halation image and the original document region becomes a dark image. As described above, the processor 51 detects an end point in the effective capturing range, and an end point of the dark image in the effective capturing range, in the image captured by the camera 55. According to such a method, the processor 51 detects an original document region from the image captured by the camera 55.

When the original document region is detected, the processor 51 captures an image of the original document on the document table 21 using the camera 55 (ACT 54). For example, the processor 51 captures an image in a range including the original document reading region of the document table 21 using the camera 55 in a usual capturing mode. When the camera 55 captures the image including the image of the original document, the processor 51 extracts image data of the original document from the captured image using the camera 55 (ACT 55). For example, the processor 51 extracts image data on the second face (rear face) of the original document by cutting out an image in the original document region in the captured image based on the detected original document region. When the image data of the original document is extracted, the processor 51 transmits the image data of the original document extracted from the captured image of the camera 55 (ACT 56) to the MFP 1, and ends the processing.

The processor 51 may perform geometric correction processing such as a rotation of an image, a trapezoid correction, or the like, with respect to image data of the original document which is cut out from the captured image. For example, the processor 51 may determine distortion of an image according to a shape of the original document region, and may perform image processing such as a correction of distortion of an image. In addition, the processor 51 may set a correction value with respect to distortion of an image caused by a setting state of the mobile terminal 2, in the adjusting processing of the effective capturing range. In this case, the processor 51 may correct image data of the original document based on a correction value which is set in the adjusting processing of the effective capturing range.

A part of the above described processing of the MFP 1 illustrated in FIG. 9 or 11 may be performed by the mobile terminal 2. In addition, a part of the above described processing of the mobile terminal 2 illustrated in FIG. 10 or 12 may be performed by the MFP 1. That is, since processing illustrated in FIGS. 9 to 12 are processing performed by the MFP 1 and the mobile terminal 2, by cooperating with each other, the processing may be performed by any one thereof. For example, in the above described operation example, the MFP 1 generates image data as a result of reading the both faces of the original document; however, the result of reading the both faces of the original document may be stored in the storage device 54 by being generated by the mobile terminal 2.

### MODIFICATION EXAMPLE

Subsequently, a modification example of the above described embodiment will be described.

In the modification example, another processing example as the double-sided processing of the original document using cooperation between the MFP 1 and the mobile terminal 2 will be described.

In the modification example, a method of extracting an original document image from an image captured by the camera 55 of the mobile terminal 2 is different from that in the above described embodiment. The MFP 1 and the mobile terminal 2 according to the modification example are set to be realized in the same hardware configuration as that in FIGS. 1 and 2 which is described in the above described embodiment. For this reason, the modification example will be described so as to be executed in the MFP 1 and the mobile terminal 2 which are illustrated in FIGS. 1 to 3. However, in the modification example, the scanner 11 of the MFP 1 is different from the above described embodiment in a point that a background face which will be described is an image pattern which will be described later.

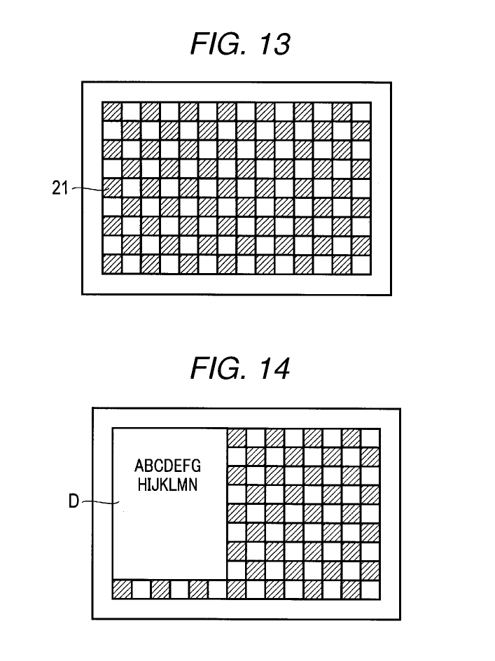

FIG. 13 illustrates an example when a document table 21 of a scanner 11 according to the modification example is viewed from above (example of captured image from upper part of document table 21). The scanner 11 has a space in which the carriage 22 moves, or for disposing the photoelectric conversion unit 24 under the document table 21. In the modification example, a wall (bottom face) when the lower space of the document table 21 is viewed from the upper part of the document table 21 is referred to as a background face. When the document table 21 is captured from above, the effective capturing range (original document reading region) becomes an image pattern of the background face, when there is no original document on the document table 21.

In the scanner 11 according to the modification example, the background face is formed using a predetermined image pattern. The image pattern of the background face may be a pattern which can be easily identified from the original document, and is not limited to a particular pattern. In FIG. 13, as an example of an image pattern on the background face, an example in which the background face is set to a check pattern is illustrated. When it is possible to obtain the captured image illustrated in FIG. 13, a region of the image pattern on the background face illustrates the effective capturing range (original document reading region).

The MFP 1 in the modification example performs setting processing of a reference image as processing corresponding to the adjusting processing of the effective capturing range in FIG. 8. The reference image is an image captured by the camera 55 of the mobile terminal 2 in a state in which the original document is not placed on the document table 21. That is, the mobile terminal 2 according to the modification example holds the image captured by the camera 55 in the state in which the original document is not placed on the document table 21 as a reference image, as the setting processing of the reference image.

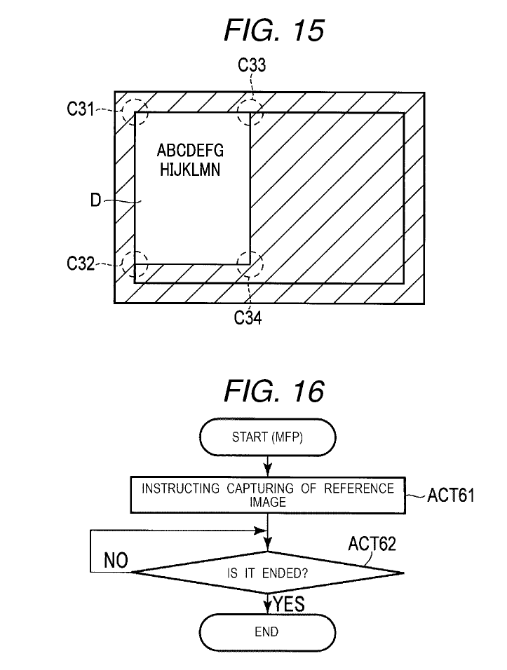

FIG. 14 is an example of the image captured by the camera 55 in a state in which the original document D as a reading target is mounted on the document table 21. In addition, FIG. 15 illustrates an example of a difference image between the captured image illustrated in FIG. 14 and the captured image (reference image) illustrated in FIG. 13.

In a difference image illustrated in FIG. 15, a pixel value (difference value with respect to captured image in FIG. 13) of the image region of the original document included in the captured image in FIG. 14 becomes large. That is, it is possible to specify the original document region by detecting four corners c31, c32, c33, and c34 in a region which surrounds a region with a large pixel value using a rectangle from the difference image.

Subsequently, double-sided processing of the original document in which the MFP 1 and the mobile terminal 2 are cooperated, as the modification example, will be described.

In the modification example, the MFP 1 executes double-sided processing of the original document in the flow illustrated in FIG. 8. However, the adjusting processing of the effective capturing range and the double-sided reading processing are different from the operations in the above described embodiment. For this reason, hereinafter, adjusting processing of the effective capturing range, and double-sided reading processing using the MFP 1 and the mobile terminal 2 will be described as an operation example of the modification example.

Subsequently, processing corresponding to the adjusting processing of the effective capturing range (setting processing of reference image) as a modification example will be described.

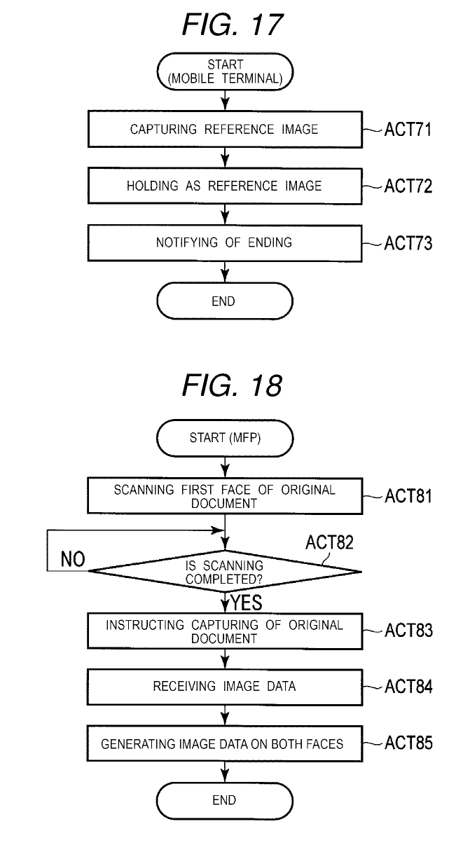

FIG. 16 is a flowchart which describes an operation example of setting processing of a reference image corresponding to the adjusting processing of the effective capturing range using the MFP 1 according to the modification example. In addition, FIG. 17 is a flowchart which describes an operation example of the setting processing of the reference image corresponding to the adjusting processing of the effective capturing range using the mobile terminal 2 according to the modification example.

When the setting processing of the reference image is instructed from the operation panel 13 of the MFP 1, as illustrated in FIG. 16, the processor 31 instructs the mobile terminal 2 to capture the reference image (ACT 21). In addition, the reference image is an image captured by the camera 55 of the mobile terminal 2 in a state in which the original document is not mounted on the document table 21. For this reason, the processor 31 may display a guide of not placing the original document on the document table 21 on the operation panel 13. In addition, the processor 31 may detect that there is no original document on the document table 21 using an original document detecting sensor. In this case, when detecting that there is the original document on the document table 21, the processor 31 may display a guide of removing the original document, or may stop the processing.

After instructing capturing of the reference image the processor 31 determines ending of the setting processing of the reference image based on a notification of ending of adjusting from the mobile terminal 2 (ACT 62). When determining ending of setting of the reference image (Yes in ACT 62), the processor 31 holds information denoting that setting of the reference image is ended in the RAM 32 or the like, and ends the processing. In addition, a difference image between the image captured by the camera 55 and the reference image may be generated on the MFP 1 side. In this case, the processor 31 of the MFP 1 may hold the reference image in the memory such as the RAM 32 by obtaining the reference image from the mobile terminal 2.

Meanwhile, as illustrated in FIG. 17, the processor 51 of the mobile terminal 2 captures the reference image using the camera 55 according to the instruction from the MFP 1 (ACT 71). As described above, the reference image is an image captured by the camera 55 in a state in which the original document is not placed on the document table 21. For this reason the processor 51 of the mobile terminal 2 captures an image using the camera 55 according to the capturing instruction from the MFP 1.

When the camera 55 captures an image as the reference image, the processor 51 holds the image captured by the camera 55 in the memory (RAM 52 or storage device 54) as the reference image (ACT 72). When holding the reference image in the memory, the processor 51 notifies the MFP 1 of a completion of setting of the reference image (ACT 73), and ends the processing. In addition, when a difference image between the image captured by the camera 55 and the reference image is generated on the MFP 1 side, the processor 51 may transmit the reference image to the MFP 1.

Subsequently, the double-sided reading processing as the modification example will be described.

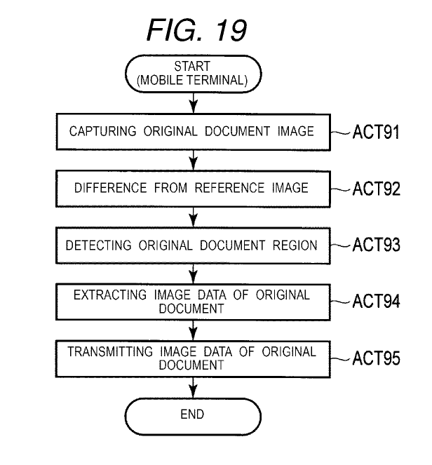

FIG. 18 is a flowchart which describes an operation example in the double-sided reading processing using the MFP 1 according to the modification example. FIG. 19 is a flowchart which describes an operation example in the double-sided reading processing using the mobile terminal 2 according to the modification example.

When the double-sided reading processing is instructed in the operation panel 13 of the MFP 1, as illustrated in FIG. 18, the processor 31 performs scanning processing in which the original document on the document table 21 is read by the scanner 11 (ACT 81). The scanner 11 optically reads an image on the lower face (first face, front face) of the original document placed on the document table 21. For example, the scanner 11 supplies image data obtained by correcting an image signal which is taken in by the photoelectric conversion sensor 47 in the image processing unit 44, or the like, to the system control unit 5 as image data on the front face of the original document. The processor 31 stores the image data on the front face of the original document supplied from the scanner 11 in the memory such as the page memory 35.

When the scanning processing is completed (Yes in ACT 82), the processor 31 instructs the mobile terminal 2 to capture the original document (image on second face (rear face) of original document) (ACT 83). After instructing capturing of the original document, the processor 31 receives image data from the mobile terminal 2 as the image on the second face (rear face) of the original document which is captured by the camera 55 (ACT 84). When receiving the image data from the mobile terminal 2, the processor 31 generates image data on both faces of the original document using the image data read by the scanner 11 and the image data received from the mobile terminal 2 (ACT 85).

The processor 31 generates a reading result of both faces of the original document in which the image data read by the scanner 11 is set to the front face, and the image data received from the mobile terminal 2 is set to the rear face. The reading result of both faces of the original document may be generated as an image file including the image data on the front face and the image data on the rear face. In addition, the processor 31 may perform processing of correcting any one or both of the image data according to characteristics of the scanner 11 and the camera 55 of the mobile terminal 2.

Meanwhile, as illustrated in FIG. 19, the processor 51 of the mobile terminal 2 captures an image including the original document on the document table 21 using the camera 55 according to the instruction from the MFP 1 (ACT 91). For example, the processor 51 captures an image in the same capturing region as that of the reference image using the camera 55. In addition, the processor 51 performs capturing, using the camera 55 in the same capturing condition as the condition in which the reference image is captured, as far as possible.

When the camera 55 captures an image, the processor 51 holds the image captured by the camera 55 in the RAM 52, or the like, and generates a difference image between the captured image and the reference image (ACT 55). When generating the difference image between the captured image and the reference image, the processor 51 detects an image in the original document region in the captured image from the generated difference image (ACT 56). For example, as described above, the processor 51 detects an original document region based on a region of which a pixel value (difference value with respect to reference image) is large in the difference image.

When the original document region in the captured image is detected, the processor 51 extracts image data on the second face (rear face) of the original document by cutting out a portion of the detected original document region from the captured image (ACT 94). When extracting the image data of the original document, the processor 51 transmits the image data of the original document which is extracted from the captured image of the camera 55 to the MFP 1 (ACT 95), and ends the processing.

In addition, a part of the above described processing of the MFP 1 illustrated in FIG. 16 or 18 may be performed by the mobile terminal 2. In addition, a part of the above described processing of the mobile terminal 2 illustrated in FIG. 17 or 19 may be performed by the MFP 1. That is, since the processing illustrated in FIGS. 16 to 19 are processing performed by the MFP 1 and the mobile terminal 2 by being cooperated with each other, the processing may be performed by any one thereof.

For example, when the difference image is generated by the MFP 1, the processing in ACTs 92 to 94 may be performed by the MFP 1. In this case, the mobile terminal 2 may transmit the image captured by the camera 55 in the same condition as that of the reference image to the MFP 1. In addition, in the above described operation example, the MFP 1 generates image data as a reading result of the both faces of the original document; however, the reading result of the both faces of the original document may be generated by the mobile terminal 2.

As described above, the MFP as the image processing device according to the embodiment and the modification example is provided with a mechanism in which a mobile terminal in which a camera is built such as a smart phone is attached to the document table cover. The MFP obtains image data of both faces of the original document by causing a scanning operation using the scanner and a capturing operation using a camera of the mobile terminal to cooperate with each other. In this manner, an image processing device in which it is possible to simply read both faces of the original document which is placed on the document table can be provided.

In the above described embodiment, correction processing in which an original document image is cut out from an image captured by a camera of the mobile terminal, a portion except for the original document is removed, or the like, is performed using light from illumination provided in the scanner. In this manner, it is possible to extract an image of the original document from an image captured by a camera with high accuracy, even when there is a degree of freedom when attaching the mobile terminal. As a result, since a high accuracy is not necessary when attaching the mobile terminal to the MFP, it is possible to execute reading processing of both faces of the original document according to the embodiment in a simple configuration.

In the above described modification example, an image captured by a camera in a state in which the original document is not placed on the document table is set to a reference image, by forming a predetermined image pattern on the rear face of the document table which is captured by the camera. In addition, an original document region is detected by a difference image between an image captured by a camera in a state in which the original document is placed on the document table and a reference image, and an original document image is extracted from the captured image. In this manner, it is possible to extract the original document image from the image captured by the camera with high accuracy, and execute reading processing of both faces of the original document in a simple configuration.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a document table includes the original document reading region on which the original document is placed;
a scanner which reads an image of the original document in the original document reading region from under the document table;
a document table cover which includes a mechanism which is openable and closeable, covers the original document reading region in a closed state, and of which a side end portion stops above the original document reading region in an open state;
a holder which is provided in the side end portion of the document table cover, and holds a mobile terminal provided with a camera in the upper part of the document table, in a state in which the document table cover is stopped in the open state;
a communication interface which communicates with the mobile terminal which is held by the holder; and
a processor which obtains image data in which the document table is captured from the upper part, using the camera of the mobile terminal, and generates image data on both faces of the original document in which image data obtained from the mobile terminal, and image data read by the scanner are combined.

2. The device according to claim 1,
wherein image data obtained from the mobile terminal is image data in an original document region which is extracted from a captured image in which the document table is captured from above using the camera, based on an image captured by the camera of the mobile terminal in a state in which the original document is not placed on the document table, and an image captured in a state in which the original document is placed on the document table.

3. The device according to claim 2,
wherein the scanner radiates light from a light source to the entire original document reading region, from under the document table, and
the original document region is detected based on an image captured by the camera of the mobile terminal in a state in which light from the light source is radiated without placing the original document on the document table, and an image captured in a state in which light from the light source is radiated by placing the original document on the document table.

4. The device according to claim 2,
wherein the original document region is detected based on a difference between an image captured by the camera of the mobile terminal in a state in which the original document is not placed on the document table, and an image captured in a state in which the original document is placed on the document table.

5. The device according to claim 4,
wherein, in the scanner, a background face when the camera of the mobile terminal captures the document table from above is a predetermined image pattern.

6. The device according to claim 1, further comprising:
a printer which forms images on both faces of a sheet based on image data on both faces of the original document which are generated by the processor.

7. A non-transitory storage medium which stores a program which causes a processor of a mobile terminal which includes a camera and a communication interface to execute:
communicating with an image processing device which includes a scanner which reads an image of the original document in an original document reading region from under a document table;
capturing an image in a region including the original document reading region using a camera, according to a capturing instruction from the image processing device, in a state in which the camera is held in the upper part of the document table;
detecting an original document region which denotes an image region of the original document as a reading target in the image captured by the camera;
extracting image data in the original document region from the image captured by the camera based on the original document region; and
transmitting image data in the original document region to the image processing device.

8. The storage medium according to claim 7,
wherein the original document region is detected based on an image captured by the camera in a state in which light is radiated to the entire original document reading region from under the document table on which the original document is not placed, and an image captured by the camera in a state in which light is radiated to the entire original document reading region from under the document table on which the original document is placed.

9. The storage medium according to claim 7,
wherein the original document region is detected based on a difference between an image captured by the camera in a state in which the original document is not placed on the document table, and an image captured by the camera in a state in which the original document is placed on the document table.

10. The storage medium according to claim 7,
wherein a program which causes the processor to execute image processing with respect to image data in the original document region which is cut out from the captured image, according to the original document region, is further stored.
